(19) United States
(12) Patent Application Publication
(10) Pub. No.: US 2014/0103735 A1
(43) Pub. Date: Apr. 17, 2014

(54) SYSTEMS AND METHODS FOR WIRELESS TRANSDUCERS THROUGH INTEGRATED ON-CHIP ANTENNA

(71) Applicant: CALIFORNIA INSTITUTE OF TECHNOLOGY, Pasadena, CA (US)

(72) Inventors: Chieh-feng CHANG, PASADENA, CA (US); Aditya RAJAGOPAL, IRVINE, CA (US); Axel SCHERER, BARNARD, VT (US)

(73) Assignee: CALIFORNIA INSTITUTE OF TECHNOLOGY, Pasadena, CA (US)

(21) Appl. No.: 14/020,508

(22) Filed: Sep. 6, 2013

Related U.S. Application Data
(60) Provisional application No. 61/714,605, filed on Oct. 16, 2012.

(51) Int. Cl. H02J 17/00

(52) U.S. Cl. CPC H02J 17/00
USPC 307/104

(57) ABSTRACT

Novel methods and systems for wireless sensors are described. The systems can comprise an energy-harvesting unit, a transducer, and electronic control circuit, and an antenna. All elements can be integrated monolithically in a single system.

### CROSS REFERENCE TO RELATED APPLICATIONS

The present application claims priority to U.S. Provisional Patent Application No. 61/714,605, filed on Oct. 16, 2012, and may be related to US Patent Application No. 12/860,723, filed on Aug. 20, 2010 (Attorney Docket P637-US), and US Patent Publication No. 2013-0207639 A1, filed on Feb. 11, 2013, the disclosure of all of which is incorporated herein by reference in their entirety.

### TECHNICAL FIELD

The present disclosure relates to wireless sensors. More particularly, it relates to systems and methods for wireless sensing with an integrated antenna.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 illustrates one embodiment of a sensing system with integrated antenna.

FIG. 2 illustrates one embodiment of a sensing system powered by optical light.

FIG. 3 illustrates a sensing system powered by optical light conveyed by an optical fiber.

FIG. 4 illustrates one embodiment of an electronic circuit in the sensing system.

### SUMMARY

In a first aspect of the disclosure, a system is described, the system comprising: an energy-harvesting unit configured to provide power to the system from electromagnetic radiation; a transducer, configured to detect measureable quantities; an electronic circuit; and an antenna; wherein the electronic circuit is configured to encode the measureable quantities and transmit them to the antenna, the antenna is configured to transmit the encoded measureable quantities, and wherein the energy-harvesting unit, the transducer, the electronic circuit and the antenna are monolithically integrated in the system.

In a second aspect of the disclosure, a system is described, the system comprising: an energy-harvesting unit configured to provide power to the system from electromagnetic radiation; a transducer, configured to detect measureable quantities; an electronic circuit; and an antenna; wherein the electronic circuit is configured to encode the measureable quantities and transmit them to the antenna, the antenna is configured to transmit the encoded measureable quantities, and wherein the transducer, the electronic circuit and the antenna are monolithically integrated in the system.

### DETAILED DESCRIPTION

The present disclosure describes a platform that features an on-chip, monolithically-fabricated antenna for communication of data measured by a wireless sensor. In some embodiments, the platform combines an energy-harvesting device that generates electricity from electromagnetic radiation, a transducer module that converts inputs of interest into current or voltage, an electronic circuit that controls other components in the system, and an antenna monolithically integrated on the same chip of the electronic circuitry. The energy-harvesting device can generate electricity from microwave or optical radiation to power the system, and the transducers converts ambient signals of interest such as temperature or chemical reaction into current or voltage. The electronic circuit then encodes the input signals, which are transmitted through the on-chip antenna. An external detector and a computing device then receive and demodulate these data into the original signals of measurement.

One advantage of the systems and methods described here is the flexibility of radio frequency communication compared with an optical data-link in terms of alignment, detection, etc. At a carrier frequency of the order of GHz or even higher, the overall platform size is still small enough for applications like implantation in biological tissues, while line-of-sight alignment of the detector is not strictly required as in the case of optical communication. Line-of-sight alignment of the detector may not be feasible under some circumstances.

The carrier frequency can be designed to take advantage of a microwave window in the absorption spectrum depending on the materials surrounding the platform, and the antenna radiation patterns can also be customized to satisfy the requirement of specific applications. For example, the radiation pattern on an antenna inside human biological tissue might point in a direction outside the tissue, in order to maximize the transmitting signal. The radiation pattern might also point in a direction which avoids a specific tissue or organ, for example to avoid unnecessary radiation being absorbed by biological tissue, either to save transmitting power, or to protect the biological tissue from adverse effects (or both).

Systems and methods are known to the person skilled in the art for wireless sensing platforms. Such platforms may combine semiconductor photovoltaics, an electrical circuit, a transducer module, and a data-link laser, as described, for example, in U.S. Pat. No. 12/860,723 and US 2013-0207639 A1, cited above, the disclosure of both of which is incorporated herein by reference in its entirety. However, the nature of the data-link laser makes the data transmission fairly directional, which under some circumstances would limit the placement of photodetectors. For example, the external space adjacent to the implanted wireless chip may be too cramped to install a photodetector module within reasonable line-of-sight alignment. Therefore, in certain circumstances, it may be advantageous to have a microwave data-link while maintaining the miniaturized feature of the entire platform. The present disclosure describes a highly-integrated, as-monolithic-as-possible implementation of wireless data communication.

In the present disclosure, a platform is described, which is fabricated with an on-chip antenna, monolithically integrated with the electronic circuit for the radio frequency (RF) communication. The entire platform can be powered by either microwave radiation or optical illumination.

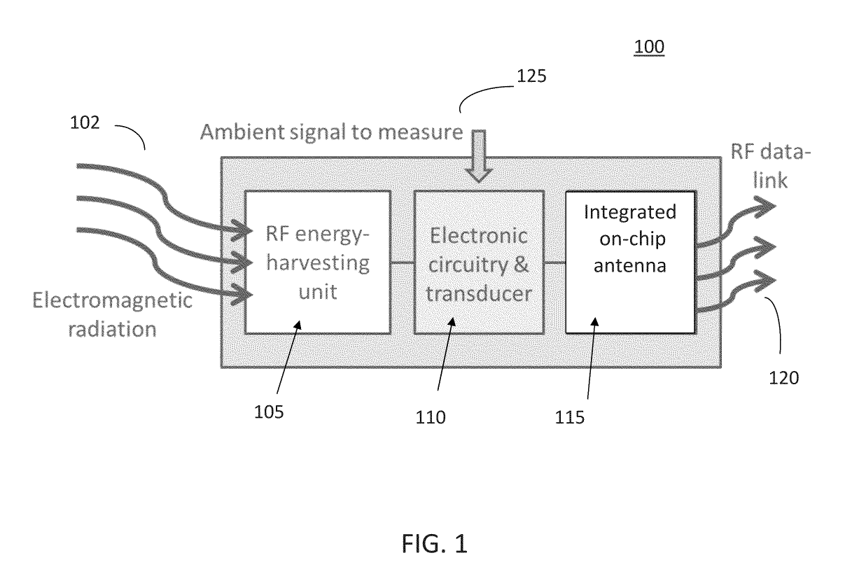

FIG. 1 illustrates one embodiment of the present disclosure, where a platform (100) is powered by RF radiation (102). An RF energy-harvesting unit (105) generates electricity to supply the electronic circuit that controls other parts of the platform (100), such as element (110), the antenna (115) and data-link (120), and so on. For example, the energy-harvesting unit (105) may be an induction coil. In some embodiments, the induction coil may be an off-chip module or a monolithically-integrated part of platform (100).

Element (110) may comprise a transducer or sensor, terms which are used interchangeably in the present disclosure. Element (110) may be able to detect and measure different kinds of environmental measureable quantities (125). These quantities (125) may be physical, chemical, or biological in nature. Examples may comprise temperature, pH value, blood sugar content, gas concentration, and so on as understood by a person skilled in the art.

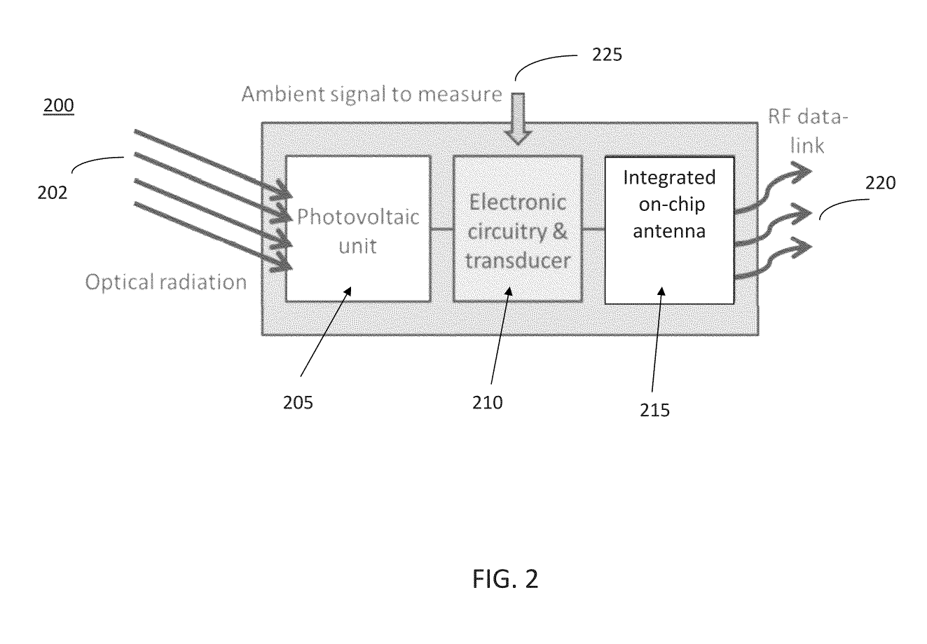

FIG. 2 illustrates another embodiment of the present disclosure, where the platform (200) is powered by optical radiation (202). A photovoltaic unit (205) generates electricity to supply the electronic circuit that controls other parts of the platform (200), such as transducer (210), the antenna (215) and data-link (220), and so on. For example, in some embodiments the photovoltaic unit (205) may be a semiconductor photovoltaic module, whether heteroepitaxial bonded (such as III-V solar cells) or monolithically integrated (such as Si photovoltaics-on-chip). Si photovoltaics-on-chip are known to the person skilled in the art. The photovoltaic unit (205) converts the optical radiation (202) into electricity to supply power.

Element (210) may comprise a transducer or sensor, able to detect and measure different kinds of environmental measureable quantities (225). These quantities (225) may be physical, chemical, or biological in nature. Examples may comprise temperature, pH value, blood sugar content, gas concentration, and so on as understood by a person skilled in the art.

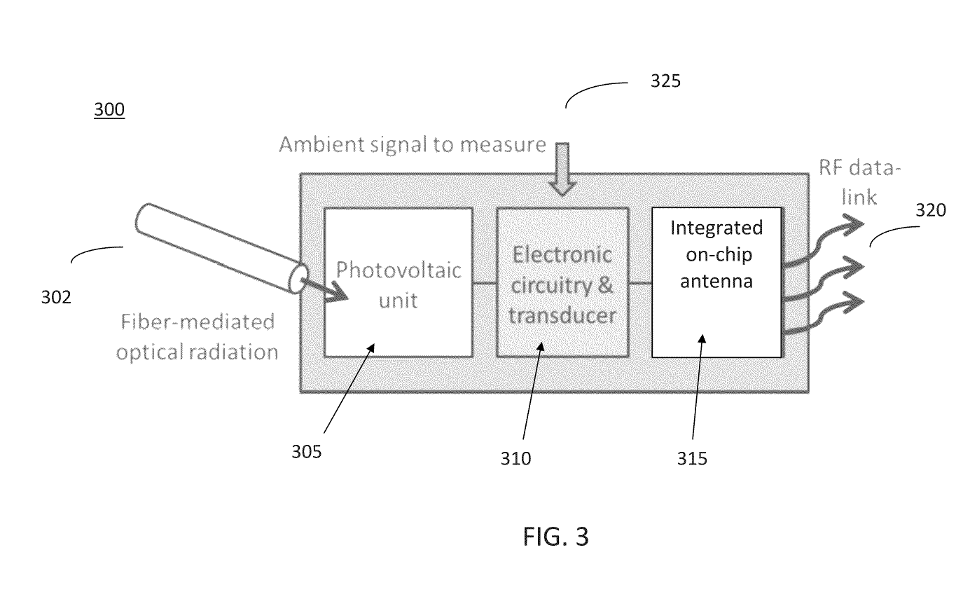

FIG. 3 illustrates another embodiment of the present disclosure, where the platform (200) is powered by fiber-mediated illumination (302). A photovoltaic unit (305) generates electricity to supply the electronic circuit that controls other parts of the platform (300), such as the transducer (310), the antenna (315) and data-link (320), and so on. For example, in some embodiments the photovoltaic unit (305) may be a semiconductor photovoltaic module, whether heteroepitaxial bonded (such as III-V solar cells) or monolithically integrated (such as Si photovoltaics-on-chip). The photovoltaic unit (305) converts the optical radiation (302) into electricity to supply power.

Element (310) may comprise a transducer or sensor, able to detect and measure different kinds of environmental measureable quantities (325). These quantities (325) may be physical, chemical, or biological in nature. Examples may comprise temperature, pH value, blood sugar content, gas concentration, and so on as understood by a person skilled in the art.

In several embodiments, the electronic circuit, the antenna driver, and the on-chip antenna can all be monolithically integrated on the same chip. One way of implementation is to submit the design to a commercial CMOS foundry for the chip.

The transducers (such as element 310 in FIG. 3) can detect and convert various inputs of interest from the environment (such as 325 in FIG. 3). Examples comprise voltage, temperature, chemical, or blood sugar fluctuation, which can be converted into current or voltage signals that, in turn, can be fed to, amplified by, or processed with an electronic circuitry. Examples of sensing devices are known to the person skilled in the art. Some examples are disclosed in U.S. patent application Ser. No. 13/941,240, filed on Jul. 12, 2013 (Attorney Docket P1170-US), the disclosure of which is incorporated herein by reference in its entirety.

The electronic circuits in the systems described in the preset disclosure may contain voltage converters, voltage regulators, energy storage, etc. if necessary, as understood by a person skilled in the art.

In order for the entire platform to be compact enough, the RF data-link is designed to operate in the frequency range of the order of GHz. A possible choice is to design the carrier frequency of the antenna to be between 1 and 100 GHz, on top of which regular coding schemes can be implemented. Since the platform is capable of being implanted in biological tissues, frequency modulation (FM) or phase modulation (PM) can be advantageous for encoding, instead of amplitude modulation (AM). The reason is that such choice can help to circumvent the problems of scattering, multi-path propagation, etc., as understood by the person skilled in the art.

Depending on the context of implantation (for example, embedded inside lipid tissues, close to blood vessels, etc.), the carrier frequency can be designed to correspond to a microwave window in the absorption spectrum of surrounding tissues to minimize the signal loss in the data transmission. The antenna radiation patterns can also be tailored according to the specific needs of the platform.

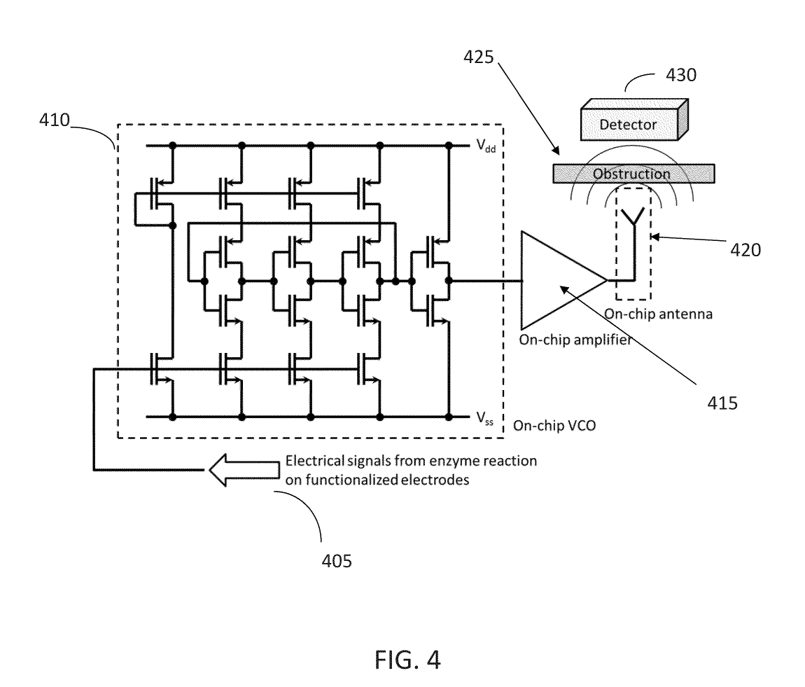

In some embodiments of the disclosure, as illustrated in FIG. 4, data (405) is detected by a transducer. For example, a sensor might measure electrical signals related to enzyme reactions on functionalized electrodes (405).

A voltage controlled oscillator (VCO) (410) on the platform can prepare the electrical signals (405) for transmission in the GHz range. An op-amp amplifier (415) can amplify the output of the VCO (410), thus driving an antenna (420).

As described above, the frequency range of the antenna (420) can be tuned, in order to enable transmission through a possible obstacle (425) between the antenna (420) and a receiver (430). For example, an obstacle (425) might be biological tissue of a human body.

Thus, data (405) is encoded for transmission, transmitted through RF signals (420), and the RF signals can then be picked up by an external microwave detector (430). The detected signals are then demodulated by a computing device to recover the original signal of measurement.

The disclosure of functionalized electrode is described, for example, in U.S. patent application Ser. No. 13/941,240, cited above. The disclosure of a VCO is known to a person skilled in the art, and described, for example, in Neil H. E. Weste et al., Principles of CMOS VLSI Design: A Systems Perspective (Addison Wesley, 2000), the disclosure of which is incorporated herein by reference in its entirety. FIG. 4 illustrates an example circuit of a VCO. As understood by a person skilled in the art, other electronic circuits may be utilized in other embodiments of the disclosure.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art a complete disclosure and description of how to make and use the embodiments of the gamut mapping of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

What is claimed is:

1. A system comprising:
an energy-harvesting unit configured to provide power to the system from electromagnetic radiation;
a transducer, configured to detect measureable quantities;
an electronic circuit; and
an antenna;
wherein the electronic circuit is configured to encode the measureable quantities and transmit them to the antenna, the antenna is configured to transmit the encoded measureable quantities, and wherein the energy-harvesting unit, the transducer, the electronic circuit and the antenna are monolithically integrated in the system.

2. The system of claim 1, wherein the energy-harvesting unit is an induction coil powered by radio-frequency radiation.

3. The system of claim 1, wherein the energy-harvesting unit is a photovoltaic unit powered by optical radiation.

4. The system of claim 3, wherein the optical radiation is conveyed through an optical fiber.

5. The system of claim 1, wherein the transducer has functionalized electrodes to detect biological or chemical quantities.

6. The system of claim 1, wherein the electronic circuit comprises a voltage-controlled oscillator.

7. The system of claim 1, wherein the antenna operates in the frequency range of 1 to 100 GHz.

8. The system of claim 1, wherein the antenna is configured to operate in a frequency range which can be transmitted through material surrounding the system.

9. The system of claim 8, wherein the frequency range is an absorption gap of the material surrounding the system.

10. The system of claim 8, wherein the material is human biological tissue.

11. The system of claim 1, wherein the antenna radiation pattern is configured to transmit signals through a desired pattern.

12. The system of claim 11, wherein the system is inside a human biological tissue and the desired pattern points in a direction outside the human biological tissue.

13. The system of claim 12, wherein the desired pattern points in a direction avoiding a specific part of the human biological tissue.

14. The system of claim 1, further comprising a receiver, not monolithically integrated on the system.

15. A system comprising:
an energy-harvesting unit configured to provide power to the system from electromagnetic radiation;
a transducer, configured to detect measureable quantities;
an electronic circuit; and
an antenna;
wherein the electronic circuit is configured to encode the measureable quantities and transmit them to the antenna, the antenna is configured to transmit the encoded measureable quantities, and wherein the transducer, the electronic circuit and the antenna are monolithically integrated in the system.

16. The system of claim 15, wherein the energy-harvesting unit is an inductor coil.

17. A method to detect measureable quantities, the method comprising:
providing the device of claim 1;
detecting the transmitted encoded measureable quantities with a receiver.

18. The method of claim 17, wherein the providing comprises inserting the device in a human body.

19. The method of claim 17, wherein the detecting is carried out through an obstacle material between the device and the receiver.
